(19) United States
(12) Patent Application Publication
(10) Pub. No.: US 2009/0008881 A1
(43) Pub. Date: Jan. 8, 2009

(54) Labyrinth Seal For Adjusting Gap

(76) Inventors: Yong Bok Lee, Seoul (KR); Chang Ho Kim, Seoul (KR); Kyoung Wook Kim, Seongnam-si (KR)

Correspondence Address: JONES DAY, 222 EAST 41ST ST, NEW YORK, NY, 10017, US

(21) Appl. No.: 12/168,773

(22) Filed: Jul. 7, 2008

(30) Foreign Application Priority Data
Jul. 6, 2007 (KR) 10-2007-0067915

(51) Int. Cl. F16J 15/447

(52) U.S. Cl. 277/412

(57) ABSTRACT

The present invention relates to a labyrinth seal used for controlling the axial leakage rate of a working fluid by using the rotating shaft of a turbo-machine such as a compressor or turbine The labyrinth seal includes: a seal disk radially extending from a rotating shaft and being formed on the rotating shaft; a seal ring spaced apart from the seal disk and being opposed to the seal disk; an actuator for moving the seal ring to adjust a gap between the seal disk and the seal ring; and a controller for controlling an operation of the actuator. By actively adjusting the gap between the seal disk and the seal ring, it is possible to effectively prevent the working fluid from leaking.

The present application claims priority from Korean Patent Application 10-2007-0067915 filed on Jul. 6, 2007, the entire subject matter of which is incorporated herein by reference.

### BACKGROUND

1. Field

The present invention relates to a labyrinth seal used for controlling the axial leakage rate of a working fluid by using the rotating shaft of a turbo-machine such as a compressor or turbine, and more particularly to a labyrinth seal with an adjustable gap adapted to control the leakage rate by active control.

2. Background

Generally, the rotating shaft of a turbo-machine is provided with a labyrinth seal, which can adjust the radial gap of the rotating shaft in order to prevent an axial leak. The axial leak is typically controlled by adjusting the gap between the rotating shaft and the labyrinth seal.

FIG. 1 illustrates a front view of a prior art labyrinth seal used for a compressor or steam turbine. As shown in FIG. 1, the prior art labyrinth seal is provided between a rotating shaft 10 and a housing 40 to encircle the rotating shaft 10. The labyrinth seal is comprised of a plurality of labyrinth seal segments 20. Elastic members 30 are disposed between the labyrinth seal segments 20. Multiple first seal strips 11 are provided on an outer circumference surface of the rotating shaft 10, while multiple second seal strips 21 are provided on a lower end of the labyrinth seal segments 20. The first and second seal strips 11, 21 do not contact each other. The first and second seal strips 11, 21 are provided in a gap formed between the rotating shaft 10 and the labyrinth seal segment 20 so as to decompress any leaking working fluid. Thus, the axial leakage rate of the working fluid decreases.

FIG. 2 is a cross-sectional view taken along the line A-A′ of FIG. 1 and illustrates a state where the gap between the rotating shaft and the labyrinth seal is maximized. FIG. 3 is a cross-sectional view taken along the line A-A′ of FIG. 1 and illustrates a state where such a gap is minimized. As shown in FIGS. 2 and 3, the distance between the labyrinth seal segments 20 is widened or narrowed by the elastic members 30 so that the gap between the rotating shaft 10 and the labyrinth seal can be adjusted. Before driving the rotating shaft 10, the distance between the labyrinth seal segments 20 is maintained at maximum by the elastic force of the elastic members 30. Thus, as shown in FIG. 2, the gap is maximally maintained. If the rotating shaft 10 rotates initially, then a stream of the working fluid develops along the rotating shaft 10. Further, the gap between the labyrinth seal segments 20 is diminished by the dynamic pressure of the working fluid. If the rotating shaft 10 rotates at a steady state, then the gap between the labyrinth seal segments 20 becomes minimal by the pressure of the working fluid. Also, the gap between the first seal strip 11 and the second seal strip 21 in the rotating shaft 10 and the labyrinth seal segments 20 is minimized. Thus, in case a force caused by the pressure difference between the front and rear sides of the labyrinth seal segments 20 is greater than the sum of the elastic force of the elastic members 30 and a friction force of contact between the housing 40 and the labyrinth seal segments 20, the leak of the working fluid can be effectively prevented.

However, since the magnitudes of the forces acting on each segment are different, it is difficult that the segments form an accurate round shape during the steady state rotation wherein the minimized gap is maintained. In such a case, it is also difficult to maintain a leak performance of the working fluid as it is designed since the radial gap between the rotating shaft 10 and the segments 20 is not uniform.

Further, when the rotating shaft is under a transient state where the rotating shaft reaches the steady state from the initial state, or when the rotating shaft rotates at its resonance frequency, or when an external force acts during the rotation of the rotating shaft to cause vibration or bending, the first and second seal strips 11, 21 can collide against each other to thereby become broken or worn. In addition, the anti-leak performance for the working fluid can be deteriorated.

Furthermore, the prior art labyrinth seal has a complex structure due to the assembly of several segments. Thus, it needs to be precisely machined. As such, the manufacture of the prior art labyrinth seal is highly difficult.

### BRIEF DESCRIPTION OF THE DRAWINGS

Arrangements and embodiments may be described in detail with reference to the following drawings in which like reference numerals refer to like elements and wherein:

FIG. 1 is a front view of a prior art labyrinth seal used for a compressor or steam turbine;

FIG. 2 is a cross-sectional view taken along the line A-A′ of FIG. 1 and illustrates a state where a gap between a rotating shaft and a labyrinth seal is maintained at maximum;

FIG. 3 is a cross-sectional view taken along the line A-A′ of FIG. 1 and illustrates a state where the gap between the rotating shaft and the labyrinth seal is maintained at minimum;

FIG. 4 is a schematic view illustrating a labyrinth seal with an adjustable gap according to a first embodiment of the present invention;

FIG. 5 is a front view of the labyrinth seal shown in FIG. 4;

FIG. 6 is a block diagram illustrating a control system of the labyrinth seal shown in FIG. 4;

FIG. 7 is a graph illustrating a displacement of a piezoelectric actuator and a leakage rate of the labyrinth seal according to time;

FIG. 8 is a schematic view illustrating a labyrinth seal according to a second embodiment of the present invention; and

FIG. 9 is a schematic view illustrating a labyrinth seal according to a third embodiment of the present invention.

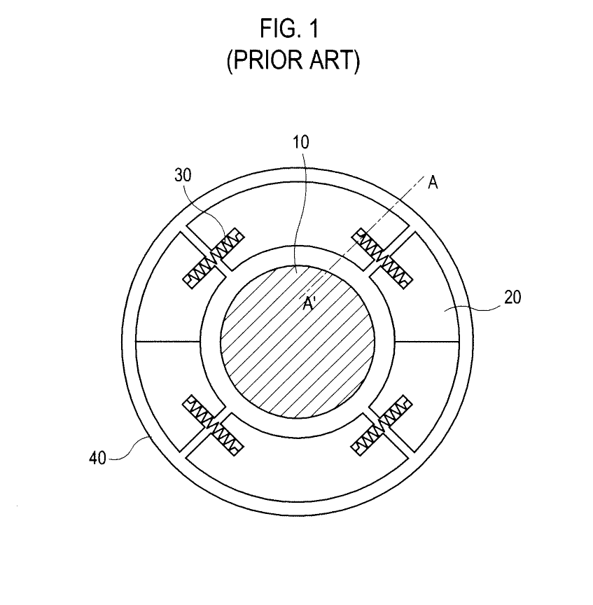

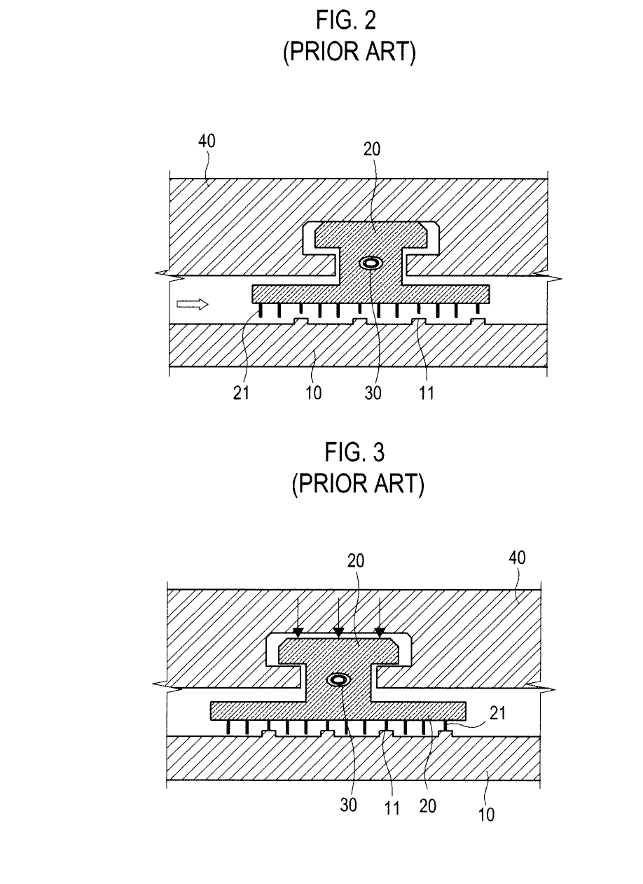

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

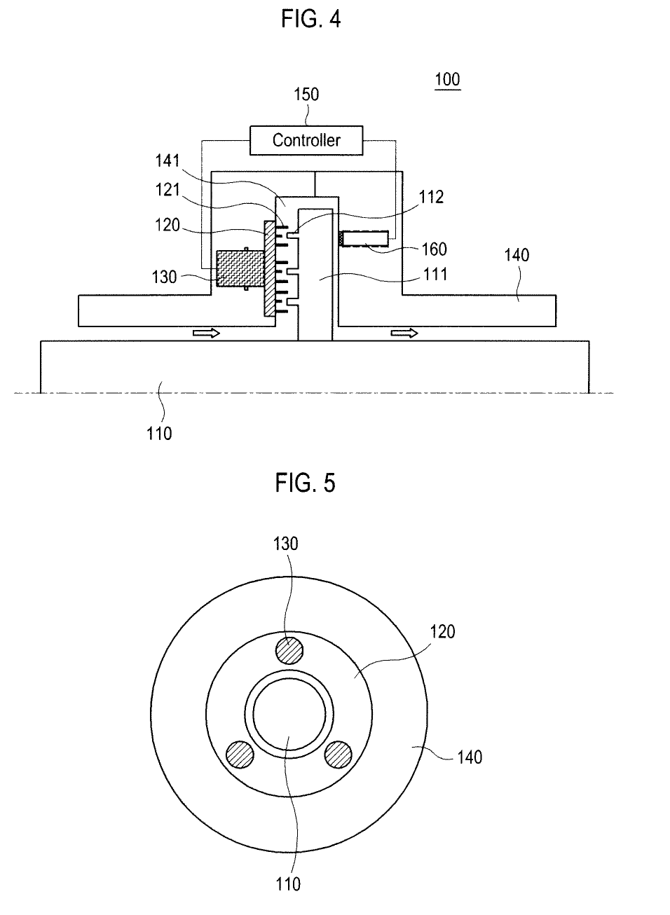

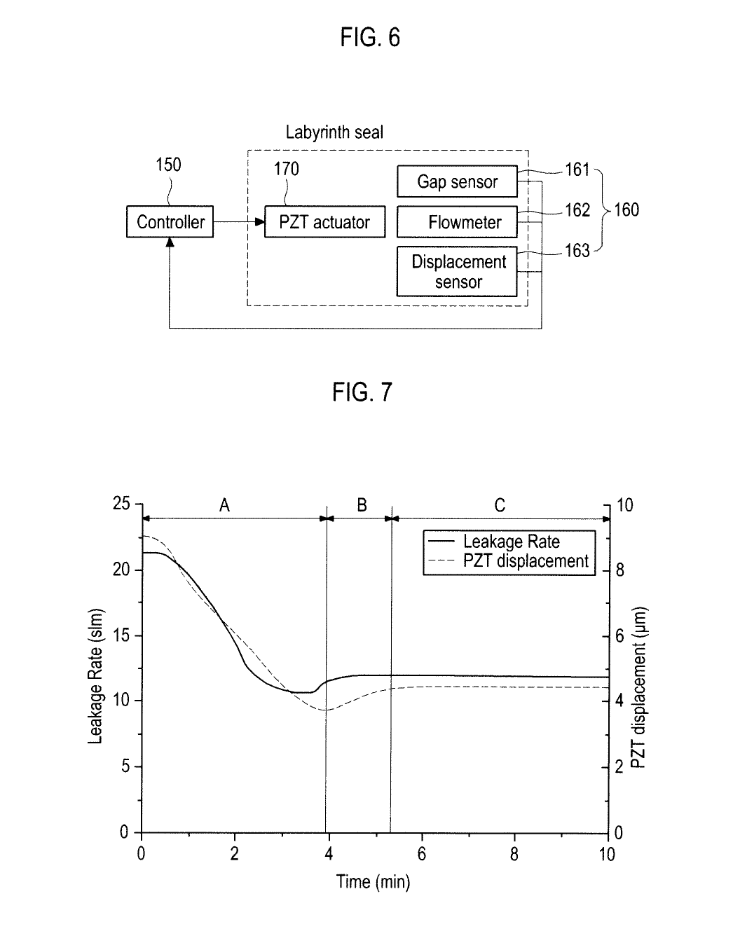

FIG. 4 is a schematic view illustrating a labyrinth seal with an adjustable gap according to a first embodiment of the present invention. FIG. 5 is a front view of the labyrinth seal shown in FIG. 4. FIG. 6 is a block diagram illustrating a control system of the labyrinth seal. As shown in FIGS. 4 to 6, a labyrinth seal 100 according to this embodiment has a seal disk 111 radially extending from a rotating shaft 110 and being formed on the rotating shaft 110. An annular seal ring 120 is disposed so as to be opposed to the seal disk 111. The seal ring 120 is allowed to be moved by a piezoelectric actuator 130 so that a gap between the seal disk 111 and the seal ring 120 is widened or narrowed. The seal disk 111 is formed with first seal strips 112, while the seal ring 120 is formed with second seal strips 121. A labyrinth seal receiver 141 is formed in a housing 140 so as to receive the seal disk 111 and the seal ring 120 therein. The piezoelectric actuator 130 is actively controlled by a controller 150 so as to move the seal ring 120. The controller 150 controls the piezoelectric actuator 130 based on the values measured at a sensor portion 160. In this embodiment, the sensor portion 160 includes the following: a gap sensor 161 for measuring the gap between the seal disk 111 radially extending from the rotating shaft 110 and the seal ring 120 attached to the piezoelectric actuator 130; a flowmeter 162 for measuring the leakage rate of a working fluid; and a displacement sensor 163 for measuring vibration, deformation, movement, etc. of the rotating shaft 110 and the seal disk 111. In order to move the seal ring 120, three piezoelectric actuators 130 are provided on the seal ring 120.

With reference to FIG. 7, the operation and functional effect of the labyrinth seal constructed in accordance with the first embodiment of the present invention will now be described.

FIG. 7 is a graph illustrating a displacement of the piezoelectric actuator and the leakage rate of the labyrinth seal according to time. As shown in FIG. 7, a target value of the leakage rate is about 12 slm (standard liter per minute). The rotating shaft 110 vibrates when a turbo-machine is initially operated. However, such a vibration diminishes when the rotating shaft rotates at a steady state. Accordingly, in order to prevent any damage of the first and second seal strips 112, 121 and the seal disk 111 during an initial rotation of the rotating shaft, the controller 150 controls the piezoelectric actuator 130 so that the gap between the seal disk 111 and the seal ring 120 is maximized. When the rotating shaft 110 begins its rotation, the working fluid flows through the labyrinth seal receiver 141 of the housing 140 by dynamic pressure. Further, the axial leakage rate of the working fluid is checked by the flowmeter 162. The controller 150 controls the piezoelectric actuator 130 so that it moves the seal ring 120 to the seal disk 111 until the leakage rate of the working fluid reaches the target leakage rate. As the gap between the seal disk 111 and the seal ring 120 is diminished, the gap between the first and second seal strips 112 and 121 is also diminished, thereby decreasing the axial leakage rate of the working fluid.

As shown in FIG. 7, in about 4 seconds after the rotation starts, the leakage rate of the working fluid reaches the target leakage rate. As passing by a transient response state where the displacement of the piezoelectric actuator 130 is adjusted in consideration of the value in the flowmeter 162, the rotation of the rotating shaft 110 and the stream of the working fluid are maintained at the steady state after about 6 seconds. Also, the displacement of the piezoelectric actuator 130 is also maintained at the steady state. Since the gap between the seal disk 111 and the seal ring 120 becomes very narrow at such a transient state, system stability becomes very low. Such a gap is adjusted in a feed-back manner by the controller 150 based on the gap and the displacement measured at the sensor portion 160.

The displacement sensor 163 detects the displacement of the rotating shaft 110 and the seal disk 111, which is caused by acceleration or deceleration of the rotating shaft 110, a vibration in a resonant frequency domain, and an impact or vibration resulting from an external force. If the displacement sensor 163 detects the displacement of more than a prescribed value, then the first seal strips 112 and the second seal strips 121 are brought into contact with each other and breakage or wear can occur. Accordingly, the controller 150 controls the piezoelectric actuator 130 so that the gap between the seal disk 111 and the seal ring 120 is expanded.

Such an active control of the labyrinth seal 100 can prevent not only a rubbing phenomenon, which occurs between the labyrinth seal and the rotating shaft, but also a system defect, which results from the vibration occurring during the rotation of the rotating shaft. This improves the life span and stability of the system while decreasing the leakage rate.

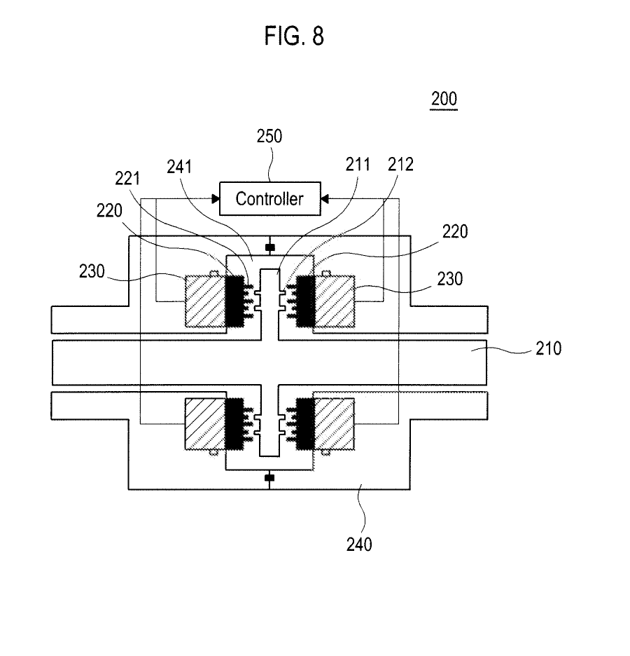

FIG. 8 is a schematic view illustrating a labyrinth seal according to a second embodiment of the present invention. As shown in FIG. 8, a labyrinth seal 200 according to this embodiment includes: a seal disk 211 extending from a rotating shaft 210 and being provided with first strips 212 on both faces thereof; a seal ring 220 having second seal strips 230; and piezoelectric actuators 230 disposed at both faces of the seal disk 211 for adjusting the position of the seal ring 220. Similar to the first embodiment, a housing 240 has a labyrinth seal receiver 241, which can receive the above-mentioned components therein. Although not shown, a flowmeter for measuring the flow rate may be provided downstream of the seal ring 220 as corresponding to the back face of the seal disk 211. Further, a displacement sensor and a gap sensor may be provided on top of the seal disk 211 or at the lower side of the housing 240.

While an operation and a functional effect of the labyrinth seal 200 according to this embodiment is similar to those of the labyrinth seal 100 according to the first embodiment, the labyrinth seal 200 can decrease more leakage rate due to more strips than those of the labyrinth seal 100.

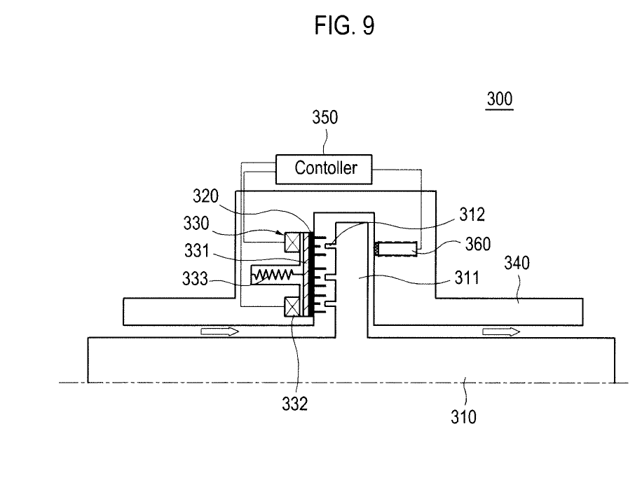

FIG. 9 is a schematic view illustrating a labyrinth seal according to a third embodiment of the present invention. Since the labyrinth seal 300 of this embodiment is configured similarly to that of the first embodiment, descriptions on the same elements are omitted herein. A seal ring 320 of the labyrinth seal 300 according to this embodiment is controlled by a solenoid actuator 330. The solenoid actuator 330 includes: an operational plate 331 coupled to the seal ring 320 and made from a ferromagnetic material; an electromagnet core 332 secured to a housing 340; and an elastic spring 333 for pushing the operational plate 331 toward a seal disk 311. The position of the operational plate 331 is controlled by adjusting the magnitude of the magnetic force of the electromagnet core 332.

Embodiments of the present invention may provide a labyrinth seal capable of adjusting a gap. The labyrinth seal can actively control the gap between a seal disk and a seal ring and can thereby precisely control the leakage rate of a working fluid. Since a decompression distance of the working fluid is increased and a flow path of the working fluid is bent by the seal disk, the leakage rate of the working fluid can be notably decreased and an operation of the system can be more stable. Since the gap between the seal disk and the seal ring can be adjusted according to the target leakage rate and the rotation state of the rotating shaft, breakage or wear resulting from friction can be eliminated and the performance and life span of the labyrinth seal can be improved.

A labyrinth seal may be provided. The labyrinth seal may comprise: a seal disk radially extending from a rotating shaft and being formed on the rotating shaft; a seal ring spaced apart from the seal disk and being opposed to the seal disk; an actuator for moving the seal ring to adjust a gap between the seal disk and the seal ring; and a controller for controlling an operation of the actuator.

One face or both faces of the seal disk may be formed with a plurality of first seal strips. Further, the seal ring may be formed with a plurality of second seal strips opposed to the first seal strips.

The labyrinth seal may further comprise a sensor portion including: a flowmeter for measuring an axial leakage rate of an working fluid in the rotating shaft; a gap sensor for measuring the gap between the seal disk and the seal ring; and a displacement sensor for measuring a displacement of the seal disk and the rotating shaft. The controller may feed-back control the actuator based on values measured at the sensor portion such that the leakage rate of the working fluid reaches a target leakage rate.

The controller may control the actuator such that the gap is maximized at an initial state of the rotating shaft and is gradually diminished after the initial state and is maintained constantly at a steady state of the rotating shaft when the leakage rate of the working fluid is equal to a target leakage rate.

When a vibration or displacement takes place in the rotating shaft due to acceleration, deceleration or an external impact during rotation of the rotating shaft, the controller may control the actuator such that the gap expands according to the vibration or displacement.

A pair of seal rings may be disposed at both faces of the seal disk.

The actuator may be a piezoelectric actuator or solenoid actuator.

Any reference in this specification to “one embodiment,” “an embodiment,” “example embodiment,” etc., means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that various other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A labyrinth seal, comprising:
a seal disk radially extending from a rotating shaft and being formed on the rotating shaft;
a seal ring spaced apart from the seal disk and being opposed to the seal disk;
an actuator for moving the seal ring to adjust a gap between the seal disk and the seal ring; and
a controller for controlling an operation of the actuator.

2. The labyrinth seal of claim 1, wherein the actuator is a piezoelectric actuator.

3. The labyrinth seal of claim 1, wherein the actuator is a solenoid actuator.

4. The labyrinth seal of claim 1, wherein one face or both faces of the seal disk is formed with a plurality of first seal strips, and
wherein the seal ring is formed with a plurality of second seal strips opposed to the first seal strips.

5. The labyrinth seal of claim 4, wherein the actuator is a piezoelectric actuator.

6. The labyrinth seal of claim 4, wherein the actuator is a solenoid actuator.

7. The labyrinth seal of claim 1, wherein the labyrinth seal further comprises a sensor portion including: a flowmeter for measuring an axial leakage rate of a working fluid in the rotating shaft; a gap sensor for measuring the gap between the seal disk and the seal ring; and a displacement sensor for measuring a displacement of the seal disk and the rotating shaft, and
wherein the controller feed-back controls the actuator based on values measured at the sensor portion such that the leakage rate of the working fluid reaches a target leakage rate.

8. The labyrinth seal of claim 7, wherein the actuator is a piezoelectric actuator.

9. The labyrinth seal of claim 7, wherein the actuator is a solenoid actuator.

10. The labyrinth seal of claim 1, wherein the controller controls the actuator such that the gap is maximized at an initial state of the rotating shaft and is gradually diminished after the initial state and is maintained constantly at a steady state of the rotating shaft when the leakage rate of the working fluid is equal to a target leakage rate.

11. The labyrinth seal of claim 10, wherein the actuator is a piezoelectric actuator.

12. The labyrinth seal of claim 10, wherein the actuator is a solenoid actuator.

13. The labyrinth seal of claim 10, wherein when a vibration or displacement takes place in the rotating shaft due to acceleration, deceleration or an external impact during a rotation of the rotating shaft, and wherein the controller controls the actuator such that the gap expands according to the vibration or displacement.

14. The labyrinth seal of claim 13, wherein the actuator is a piezoelectric actuator.

15. The labyrinth seal of claim 13, wherein the actuator is a solenoid actuator.

16. The labyrinth seal of claim 1, wherein a pair of the seal rings are disposed at the both faces of the seal disk.

17. The labyrinth seal of claim 16, wherein the actuator is a piezoelectric actuator.

18. The labyrinth seal of claim 16, wherein the actuator is a solenoid actuator.
